(19) United States
(12) Patent Application Publication
(10) Pub. No.: US 2019/0018367 A1
(43) Pub. Date: Jan. 17, 2019

(54) OSCILLATING WINDING WEIGHT FOR A TIMEPIECE WITH AN AUTOMATIC MOVEMENT AND TIMEPIECE FITTED WITH SUCH A WINDING WEIGHT

(71) Applicant: ETA SA Manufacture Horlogere Suisse, Grenchen (CH)

(72) Inventors: Yassine RACHDI, Joncherey (FR); Julien HUSER, Pery (CH); Ambre COFFIN, Bienne (CH)

(73) Assignee: ETA SA Manufacture Horlogere Suisse, Grenchen (CH)

(21) Appl. No.: 16/022,907

(22) Filed: Jun. 29, 2018

(30) Foreign Application Priority Data
Jul. 11, 2017 (EP) 17180736.5

(51) Int. Cl. G04B 5/18; G04B 5/10

(52) U.S. Cl. CPC G04B 5/18; G04B 5/10

(57) ABSTRACT

An oscillating winding weight for a timepiece movement including a heavy portion fixed to a connecting element intended to connect the heavy portion to an arbor integral with a movement, the oscillating winding weight being intended to be rotatably mounted on the arbor, the connecting element being made of a transparent or translucent material. According to the invention, the connecting element includes at least one coloured filter.

This application claims priority from European Patent Application No. 17180736.5 filed on Jul. 11, 2017, the entire disclosure of which is hereby incorporated herein by reference.

### FIELD OF THE INVENTION

The present invention concerns an oscillating winding weight for a timepiece with an automatic movement. More particularly, the invention concerns a winding weight of this type intended to be fitted to a wristwatch comprising a transparent back cover, said weight being arranged on the side of the back cover of the case and allowing permanent observation of the entire movement.

### BACKGROUND OF THE INVENTION

Wristwatches having cases with transparent back covers to allow their movement to be observed are already known. However, when these watches comprise a movement with an automatic winding mechanism, observation of the movement is always curtailed by the presence of the oscillating winding weight which, even when openworked, as is the case in so-called ‘skeleton’ watches, prevents comfortable observation of the movement.

To overcome this problem, EP Patent No. 0957414 proposed an oscillating winding weight comprising a heavy portion secured to a connecting element to connect said heavy portion to an arbor integral with a movement, said connecting element being made of a transparent or translucent material. Such an oscillating winding weight allows the movement to which it is fitted to be observed with no visible obstacles. However, certain elements of the movement, which appear through the oscillating winding weight and through the transparent back cover of the watch, have their usual metallic appearance while the rest of the watch may be very colourful. Although colour can be added to some fixed elements of the movement frame without difficulty, the same is not true of the moving parts of the gear train, such as parts of the going train, of the escapement or of the oscillator. It is complex to add colour to these moving parts. Indeed, the functionality of these parts, which require high precision and the least possible friction in order to operate properly, could not be guaranteed following application of a coloured film, for example.

### SUMMARY OF THE INVENTION

It is an object of the present invention to overcome the drawbacks of the aforementioned prior art by proposing an oscillating winding weight for a timepiece that allows the parts of the movement to which it is fitted to be given a colour without harming the functionality of such parts.

To this end, the invention concerns an oscillating winding weight for a timepiece movement comprising a heavy portion fixed to a connecting element connecting said heavy portion to an arbor fixed to a movement, said weight being intended to be rotatably mounted on said arbor, said connecting element being made of a transparent or translucent material.

According to the invention, said connecting element comprises at least one coloured filter.

As a result of this novel winding weight structure, it is possible to make the whole of the timepiece movement to which it is fitted permanently visible, and to give the visible parts of the movement a coloured appearance, in a different colour from their real colour, which gives the timepiece an improved aesthetic appearance, without harming the functionality of such parts.

Said coloured filter can occupy at least part of the surface of the connecting element.

According to a particularly preferred embodiment of the invention, the coloured filter occupies the entire surface of the connecting element and is preferably formed by a mass-coloured component of the transparent or translucent material.

According to another aspect, the invention also concerns a timepiece comprising a case formed of a case middle closed by a crystal and an at least partially transparent back cover and inside which is housed a timepiece movement with an automatic winding mechanism, said movement being fitted with an oscillating winding weight as defined above.

### BRIEF DESCRIPTION OF THE DRAWINGS

Other details of the invention will appear more clearly upon reading the following description, made with reference to the annexed drawings, in which:

FIG. 1 is a plan view of a first embodiment of an oscillating winding weight according to the invention.

FIG. 2 is a cross-section along the line II-II of FIG. 1.

FIG. 3 is a plan view of a second embodiment of an oscillating winding weight according to the invention.

FIG. 4 is a cross-section, similar to that of FIG. 2, of a third embodiment of the invention.

FIG. 5 is a plan view of a fourth embodiment of an oscillating winding weight according to the invention.

FIG. 6 is a partial cross-section along the line VI-VI of FIG. 5.

FIG. 7 is a cross-section of a fifth embodiment of the invention.

### DETAILED DESCRIPTION OF A PREFERRED EMBODIMENT

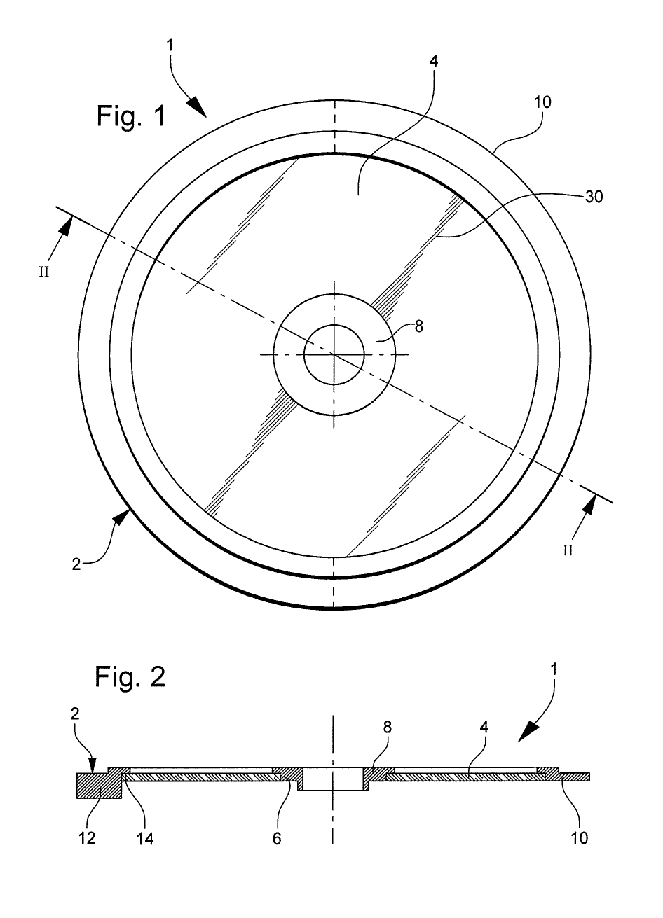

FIGS. 1 and 2 represent a first embodiment of an oscillating winding weight according to the invention, designated by the general reference 1. This weight is intended to be fitted in a conventional manner to the automatic or self-winding movement of a timepiece (not represented) and comprises, in particular, a case formed of a case middle closed by a crystal and an at least partially transparent back cover to make the movement visible from the back cover.

Winding weight 1 comprises a heavy portion 2 fixed to a connecting element 4 intended to connect the heavy portion to an arbor (not represented) integral with a timepiece movement, weight 1 being intended to be rotatably mounted on said arbor. To this end, the connecting element comprises at its centre an opening 6, into which is driven a ring 8, forming the hub of weight 1.

In this variant, connecting element 4 is formed of a full disc made of a transparent material such as sapphire, which allows the movement to be observed through weight 1. It is recalled that the use of sapphire in a winding weight as connecting element between the heavy portion and the movement goes against the preconceived ideas of those skilled in the art who, when designing a winding weight, always tend to use materials having high resistance, i.e. good capacity to absorb the shocks to which the weight is subjected during its rotation. It is evident that any other transparent or translucent, synthetic or natural material can be used. For example, a polycarbonate suitable for this application can be used. In all cases, the material will at least have to allow light to pass through in order to distinguish the shapes of the elements situated behind it.

Heavy portion 2 comprises a ring 10 which comprises, on an arc of a circle of approximately 180°, an unbalance 12, which is formed by an overthickness of said ring 10. In the illustrated example, ring 10 and unbalance 12 are made in one piece. Preferably, heavy portion 2 is made of a high density metal, for example, a tungsten alloy. However, it is evident that, according to a variant, unbalance 12 can be secured to ring 10 by any conventional securing means, such as screwing, bonding, crimping, soldering or suchlike. In that case, ring 10 can be made of a material that is easy to machine, such as steel, and unbalance 12 of a tungsten alloy. In the example shown, ring 10 comprises a rabbet 14 in which disc 4 is engaged and bonded. However, it is evident that according to a variant, this disc 4 can be fixed in rabbet 14 of ring 10 by any other conventional securing means, such screwing, riveting or suchlike. Preferably, ring 10 has a decoration on its external surface, i.e. visible from the back cover of the watch. This decoration preferably occupies the whole of the external visible surface of the ring.

According to the invention, connecting element 4 comprises at least one coloured filter 30, which occupies the whole of the surface of connecting element 4.

According to another variant of the invention, the coloured filter may occupy only part of the surface of the connecting element. For example, the coloured filter may be in the form of a strip, a continuous or discontinuous ring, arranged on the connecting element substantially level with the visible parts of the movement which one wishes to give a coloured appearance, at least temporarily, according to the rotational motion of the oscillating winding weight.

Preferably, said coloured filter 30 can be formed by a coloured component within the transparent or translucent material. For example, a dye, a pigment or a mixture of dyes and pigments, diffused through the transparent or translucent material, will be used. This embodiment will be particularly preferred when the coloured filter occupies the whole of the surface of the connecting element.

When the transparent or translucent material is polycarbonate, the dyed-in-the-mass connecting element 4 may, for example, be obtained from a compound comprising polycarbonate, a pigment or a mixture of pigments and a dispersing agent. This compound is then injected to obtain connecting element 4. It is also possible to use a pigment directly in liquid form. Any pigment compatible for dying in the mass the transparent or translucent material can be used.

According to another embodiment, the coloured filter can be formed by a transparent or translucent coloured film deposited on at least one part of the surface of connecting element 4. This film may be a varnish or an ink. It can be deposited on the internal surface (movement side) or external surface (back cover side) of connecting element 4. This embodiment can be implemented to form a coloured filter that occupies all or part of the surface of the connecting element.

Further, in a particularly advantageous manner, at least one element of the movement which is at least partially visible from the back of the movement and can be at least partially seen through the coloured filter, has a neutral colour, for example grey, with a matt effect. This neutral colour is chosen so as not to reduce, or to reduce as little as possible, the effect of the coloured filter. Thus, connecting element 4 acts as a coloured filter and gives the illusion that the elements visible from the back of the movement are coloured, with a different colour from their real colour. The invention thus allows the elements visible from the back of the movement to be given a different colour from their natural colour, without harming their functionality. Depending on whether the coloured filter occupies all or part of the surface of the connecting element, the effect of the coloured appearance given to the elements visible from the back of the movement is permanent or temporary but repeated according to the rotational motion of the oscillating winding weight.

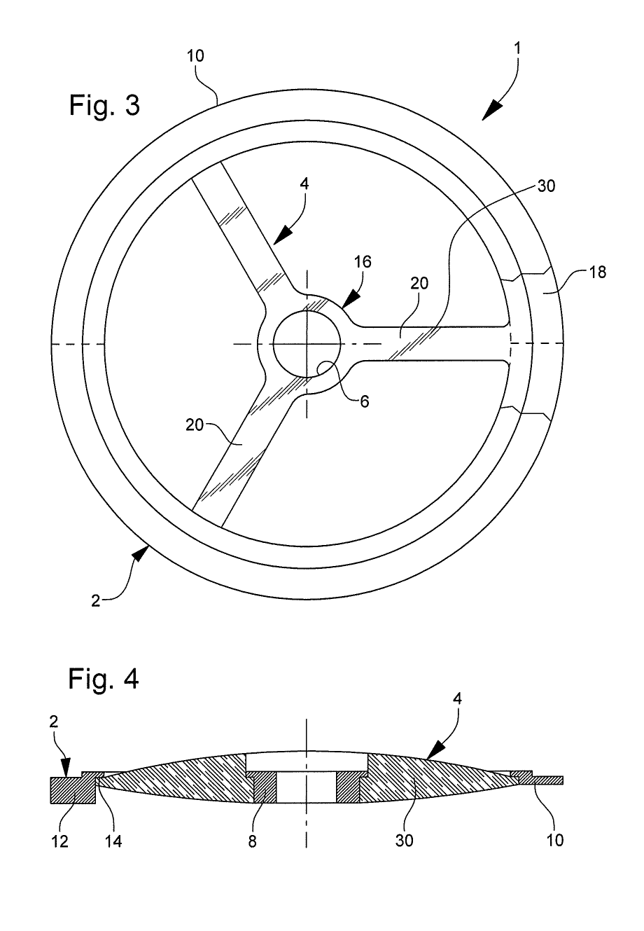

FIG. 3 shows a second embodiment of an oscillating winding weight 1 according to the invention. In this Figure and the subsequent Figures, those elements which are identical to those described above with reference to FIGS. 1 and 2 will be designated by the same reference numerals. It will be noted that, for the sake of clarity, ring 8 forming the hub of weight 1 has been omitted from FIG. 3.

Unlike the embodiment shown in FIGS. 1 and 2, connecting element 4 of this embodiment is formed of a partially hollowed disc which is also made of sapphire. More precisely, connecting element 4 comprises a central portion 16 provided with opening 6 and a peripheral ring 18 concentric with opening 6 central portion 16 being connected to peripheral ring 18 by three connecting arms 20. The recessed portions of disc 4 will advantageously be made using diamond grinding wheels or using a laser beam. Connecting element 4 is dyed in the mass to form a coloured filter 30.

FIG. 4 shows a third embodiment of an oscillating winding weight 1 according to the invention wherein connecting element 4 is formed of a circular optical magnifying lens dyed in the mass to form a coloured filter 30. It is evident that, according to variant embodiments, any other type of optical lens can be envisaged. In particular, Fresnel lenses, which have the peculiarity of being flatter than a conventional lens for a given magnification, could be provided. It is also possible to envisage using lenses producing kaleidoscopic effects for connecting elements 4.

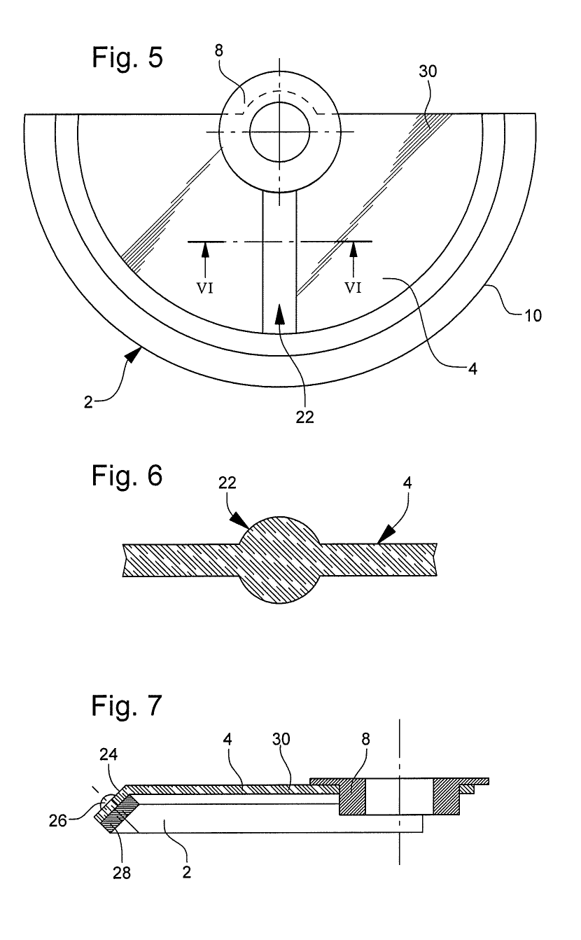

FIGS. 5 and 6 represent a fourth embodiment of an oscillating winding weight 1 of the invention, wherein connecting element 4 is formed of a transparent plate shaped into an angular sector extending over approximately 180° and wherein heavy portion 2 is formed by a ring portion extending at the periphery of plate 4 over an arc of a circle of approximately 180°. Plate 4 is made of sapphire, dyed in the mass to form a coloured filter 30, and further comprises an optical magnifying lens 22 which extends radially from ring 8 to the ring of heavy portion 2.

FIG. 7 shows a fifth embodiment of an oscillating winding weight 1 according to the invention, wherein connecting element 4 is formed of a transparent plate dyed in the mass to form a coloured filter 30, in the shape of an angular sector extending over approximately 180° and comprising at its periphery an edge 24 bent at an angle. In this embodiment, heavy portion 2 is also formed by a ring portion extending over an arc of a circle of approximately 180° and secured by means of screws 26 to the inner face 28 of edge 24. It will be noted that, owing to bent edge 24, this embodiment of winding weight 1 allows a better fit to the outer shape of the movement to which it is intended to be fitted, since edge 24 is bent in the direction of the movement.

1. An oscillating winding weight for a timepiece movement comprising a heavy portion fixed to a connecting element intended to connect said heavy portion to an arbor integral with a movement, said oscillating winding weight being intended to be rotatably mounted on said arbor, said connecting element being made of a transparent or translucent material, wherein said connecting element comprises at least one coloured filter.

2. The oscillating winding weight according to claim 1, wherein said coloured filter occupies at least one part of the surface of the connecting element.

3. The oscillating winding weight according to claim 1, wherein said coloured filter occupies all of the surface of the connecting element.

4. The oscillating winding weight according to claim 1, wherein said coloured filter is formed by a coloured component provided within the transparent or translucent material.

5. The oscillating winding weight according to claim 4, wherein the transparent or translucent material is polycarbonate.

6. The oscillating winding weight according to claim 1, wherein said coloured filter is formed by a coloured transparent or translucent film deposited on at least one part of the surface of the connecting element.

7. The oscillating winding weight according to claim 1, wherein said connecting element is formed of a full disc.

8. The oscillating winding weight according to claim 1, wherein said connecting element is formed of an at least partially openworked disc.

9. The oscillating winding weight according to claim 1, wherein said connecting element is formed of at least two connecting arms.

10. The oscillating winding weight according to claim 1, wherein said connecting element is made of sapphire.

11. The oscillating winding weight according to claim 1, wherein said connecting element comprises an optical lens.

12. The oscillating winding weight according to claim 1, wherein said heavy portion is formed of a ring portion extending over an arc of a circle of approximately 180°.

13. The oscillating winding weight according to claim 1, wherein said heavy portion is formed of a circular ring comprising, over an arc of a circle of approximately 180°, an unbalance.

14. The oscillating winding weight according to claim 1, wherein said heavy portion is fixed to said connecting element by bonding.

15. A timepiece comprising a case formed of a case middle closed by a crystal and an at least partially transparent back cover and inside which is housed a timepiece movement with an automatic winding mechanism, wherein said movement is fitted with an oscillating winding weight according to claim 1.

16. The timepiece according to claim 15, wherein said movement comprises at least one element that is at least partially visible from the back of the movement and able to be at least partially seen through the coloured filter, said element having a neutral colour.
